(19) United States
(12) Patent Application Publication
(10) Pub. No.: US 2025/0319918 A1
(43) Pub. Date: Oct. 16, 2025

(54) A LOAD MOVING APPARATUS

(71) Applicant: M-MOVER HOLDINGS LIMITED, Ashbourne, Derbyshire (GB)

(72) Inventors: Andrew OWEN, Ashbourne, Derbyshire (GB); James JONES, Ashbourne, Derbyshire (GB); Stephen ANTILL, Ashbourne, Derbyshire (GB); William HEALEY, Ashbourne, Derbyshire (GB)

(21) Appl. No.: 18/869,917

(22) PCT Filed: May 31, 2023
(86) PCT No.: PCT/GB2023/051439

§ 371 Date: Nov. 27, 2024

(30) Foreign Application Priority Data
Jun. 1, 2022 (GB) 2208097.2

(51) Int. Cl. B62B 3/06; B62B 5/00

(52) U.S. Cl. CPC B62B 3/0612; B62B 5/0036

(57) ABSTRACT

A load moving apparatus including: a main body having a receiving portion for receiving a weight member; at least one ground engaging device supported on or by the main body; wherein the apparatus is configured to adopt either of first or second respective configurations; wherein in the first configuration a first weight member is receivable by the receiving portion, and in the second configuration a second weight member is receivable by the receiving portion, and wherein the first weight member is different to the second weight member.

### INTRODUCTION

Embodiments of the present invention relate to a load moving apparatus. More particularly, this invention relates to a load moving apparatus for use by a pedestrian.

### BACKGROUND

Load moving apparatus are used to assist a user with moving large or heavy goods. Such apparatus typically include a ground engaging wheel, or set of wheels, which may or may not be connected to a source of power. To move a load, such apparatus are typically configured to engage with a load such that the load may be pushed or pulled.

Embodiments of the present invention seek to alleviate one or more problems associated with the prior art.

### BRIEF DESCRIPTION OF THE INVENTION

According to a first aspect of the invention we provide a load moving apparatus including:
a main body having a receiving portion for receiving a weight member;
at least one ground engaging device supported on or by the main body;
wherein the apparatus is configured to adopt either of first or second respective configurations; wherein in the first configuration a first weight member is receivable by the receiving portion, and in the second configuration a second weight member is receivable by the receiving portion, and wherein the first weight member is different to the second weight member.

The main body may include a first end and a second end.

The at least one ground engaging device may be positioned at or close to the first end.

The receiving portion may be positioned at or close to the first end of the main body.

The main body may include a first lateral side and a second lateral side.

The main body may be intersected by a substantially vertical plane B, said plane B positioned between the first and second lateral sides of the main body.

The first or second weight member may be receivable by the receiving portion on the first lateral side.

A further first weight member may be receivable by the receiving portion on the second lateral side.

A further second weight member may be receivable by the receiving portion on the second lateral side.

The load moving apparatus may include a first weight member received by the receiving portion.

The first weight member may include first and second portions.

The first portion may be inclined relative to the second portion.

The at least one ground engaging device may be configured for rotation about a substantially horizontal axis A.

In use, the first and/or second portion of the first or second weight member may be at least partially positioned or may extend below the axis A.

In use, the first and/or second portion of the first or second weight member may be at least partially positioned or may extend above the axis A.

In use, the first and/or second portion of the first or second weight member may be at least partially positioned or may extend forwardly of the axis A.

In use, the first and/or second portion of the first or second weight member may be at least partially positioned or may extend rearwardly of the axis A.

The first weight member may comprise a cast iron and/or a steel alloy.

The first weight member may be formed from a plurality of sheets.

The plurality of sheets may include a first sheet and a second sheet.

The first sheet may have a first shape.

The second sheet may have a second shape.

The second shape may be different to the first shape.

The load moving apparatus may include a further first weight member received by the receiving portion.

The first weight member may be received by the receiving portion on the first lateral side.

The further first weight member may be received by the receiving portion on the second lateral side.

In the first configuration the receiving portion may be in a first configuration.

In the second configuration the receiving portion may be in a second configuration.

The receiving portion may include at least one receiving formation for receiving a part of a first weight member.

The receiving portion may include at least one receiving formation for receiving a part of a second weight member.

The receiving portion may include a plurality of receiving formations for receiving a part of the first and/or second weight members.

The plurality of receiving formations may include a first formation for receiving a part of a first weight member.

The plurality of receiving formations may include a second formation for receiving a part of a second weight member.

The first formation for receiving a part of the first weight member may include at least one aperture, and/or the second formation for receiving a part of the second weight member may include at least one aperture.

The at least one aperture of the first and/or second formation may be at least partially threaded.

The main body may include a further receiving portion.

A third weight member may be receivable by the further receiving portion.

The further receiving portion for receiving a third weight member may extend away from the first end of the main body.

The further receiving portion may extend in a direction generally perpendicular to an axis of the main body.

The further receiving portion may extend in a direction substantially parallel to a plane B which intersects the main body.

The load moving apparatus may include a third weight member wherein the third weight member may be received by the further receiving portion.

The third weight member may include one or more or all of the features of the first weight member.

The load moving apparatus may further include:
a drive member for driving the at least one ground engaging device; and
at least one transmission member operably connected to the drive member and the ground engaging device for transmitting drive from the drive member to the ground engaging device for rotating the device about a or the axis A.

The load moving apparatus may include an attachment member for attaching the at least one transmission member to the main body.

In the first configuration the attachment member may be attached to the main body.

In the second configuration the attachment member may be detached from the main body.

The load moving apparatus may include:
a further ground engaging device;
a further drive member for driving the further ground engaging device; and
a further transmission member operably connected to the further drive member and the further ground engaging device for transmitting drive from the further drive member to the further ground engaging device; and
a further attachment member for attaching the further transmission member to the main body.

The ground engaging device, drive member and transmission member may be positioned to the first lateral side.

The further ground engaging device, further drive member and further transmission member may be positioned to the second lateral side.

The attachment member may be positioned on the first lateral side.

The transmission member may be receivable at least partially by the attachment member.

The further attachment member may be positioned on the second lateral side.

The further transmission member may be receivable at least partially by the second attachment portion.

The first weight member may extend at least partially around the transmission member.

In use, the main body may be inclined at an angle to a surface.

The load moving apparatus may include a user graspable handle.

The main body may include first and second respective ends, the first end being positioned closer to a surface in use than the second end.

The ground engaging device may be positioned at the first end.

The user graspable handle may be positioned at the second end.

The load moving apparatus may include a castor wheel assembly.

The castor wheel assembly may be positioned rearwardly of the first end and under the second end.

According to a second aspect of the invention we provide a load moving apparatus for use by a pedestrian including:
a main body;
a battery compartment for receiving a battery device, the battery compartment supported on or by the main body;
wherein the battery compartment includes a receiving portion for receiving a weight member; and
a weight member received by the receiving portion, said weight member being positioned adjacent the battery device, in use.

The weight member may be received by the receiving portion on a first lateral side of the battery device, in use.

The load moving apparatus may further include a further weight member, wherein the further weight member is received by the receiving portion on a second, generally opposite, lateral side of the battery device, in use.

The load moving apparatus according to the second aspect of the invention may include one or more or all of the features of the load moving apparatus according to the first aspect of the invention.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a perspective view of a load moving apparatus for use by a pedestrian in accordance with the present disclosure;

FIG. 2 is a side view of the load moving apparatus of FIG. 1;

FIG. 3 is a plan view of the load moving apparatus of FIG. 1;

FIG. 4 is a rear view of the load moving apparatus of FIG. 1 with a housing removed;

FIG. 5a is a perspective view of a chassis member of the load moving apparatus of FIG. 1;

FIG. 5b is a side view of a chassis member of the load moving apparatus of FIG. 1;

FIG. 6 is an enlarged side view of detail 6-6 of FIG. 5a;

FIG. 7 is a side view of the chassis member FIG. 5a with an attachment member attached;

FIG. 8 is a perspective view of the chassis member of FIG. 5a with an attachment member and a further attachment member attached;

FIG. 9 is a side view of the chassis member FIG. 7 with a first weight member attached;

FIG. 10 is a side view of the chassis member FIG. 9 with a drive member and transmission member attached;

FIG. 11 is a perspective view of the chassis member of FIG. 10 according to a first configuration of the apparatus;

FIG. 12 is a perspective view of the chassis member of FIG. 10 according to a second configuration of the apparatus;

FIG. 13 is a side view of the load moving apparatus of FIG. 1 with a ground engaging device and a housing removed;

FIG. 14 is an enlarged side view of detail 14-14 of FIG. 13;

FIG. 15a is a plan view of the load moving apparatus of FIG. 1 with a load engagement device in a second or third position;

FIG. 15b is a plan view of the load moving apparatus of FIG. 1 with a load engagement device in a first position;

FIG. 15c is a plan view of the load moving apparatus of FIG. 1 with a load engagement device in a second or third position;

FIG. 16a is a front view of the load moving apparatus of FIG. 1 with a load engagement device in a second or third position;

FIG. 16b is a front view of the load moving apparatus of FIG. 1 with a load engagement device in a second or third position;

FIG. 17 is a side view of the load moving apparatus of FIG. 1 with a ground engaging device and a housing removed;

FIG. 18 is a rear perspective view of the load moving apparatus of FIG. 1 showing a third weight member and a further third weight member;

FIG. 19 is a rear perspective bottom view of the load moving apparatus of FIG. 1 showing a third weight member and a further third weight member;

FIG. 20 is a rear perspective bottom view of the load moving apparatus of FIG. 1 with a ground engaging device removed and showing a third weight member and a further third weight member;

FIG. 21a is a perspective view of the load moving apparatus of FIG. 1 with a cover removed and a hydraulic pump provided on the main body; and

FIG. 21b is a perspective view of the load moving apparatus of FIG. 21a with the hydraulic pump replaced with a cable-actuated actuator provided on the main body.

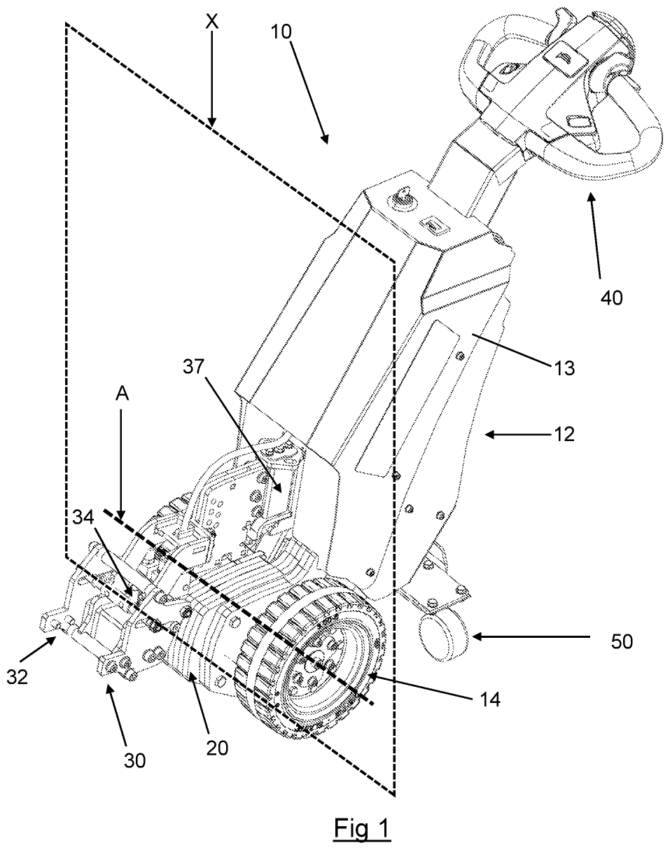

### DETAILED DESCRIPTION OF THE DISCLOSURE

Referring to the figures there is provided a load moving apparatus 10 in accordance with the present disclosure. The load moving apparatus 10 may be for use by a pedestrian, i.e., it is for use by a person not in a vehicle. The load moving apparatus 10 includes a main body 12, at least one ground engaging device 14, at least one drive member 16 and at least one transmission member 18. In embodiments, the apparatus 10 may also include at least one weight member 20, a load engagement device 30, a user graspable handle 40, a castor wheel assembly 50 and a power receptacle 60. These are described in more detail below.

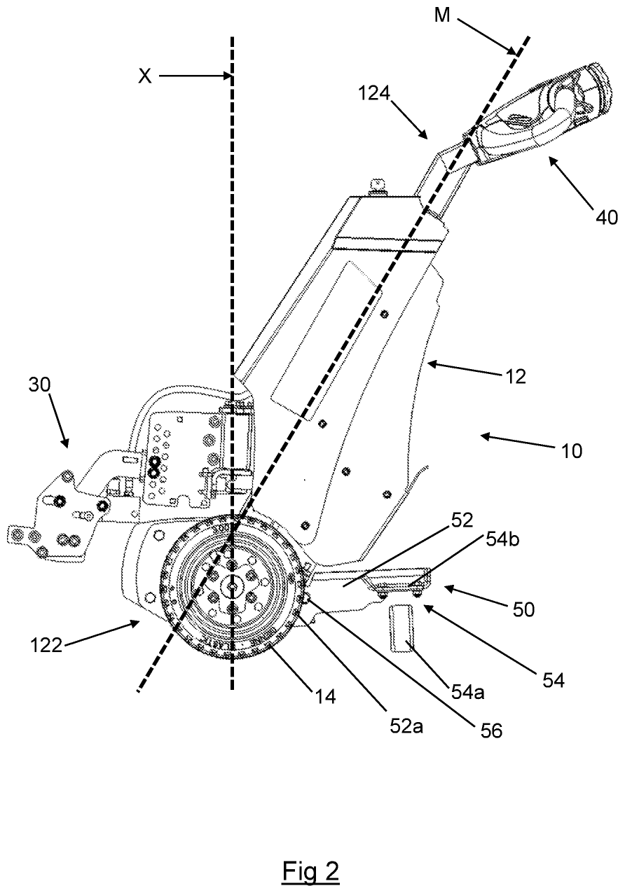

The main body 12 supports components of the apparatus 10. As shown in FIG. 2, the main body 12 may include a first end 122 and a second end 124. An axis M may extend between the first and second ends 122, 124. The axis M may be a main axis of the main body 12. In other words, the axis M may be positioned generally centrally of the main body 12.

The main body includes a front portion 12a and a rear portion 12b. In embodiments, the main body 12 is intersected by a substantially vertical plane X. As shown in FIG. 2, the vertical plane X may be intersected by the axis M. The vertical plane X is positioned between the front portion 12a of the main body 12, e.g., the front portion 12a may be located on one side of the plane X, and the rear portion 12b of the main body 12, e.g., the rear portion 12b may be located on the opposite side of the plane X relative to the front portion 12a.

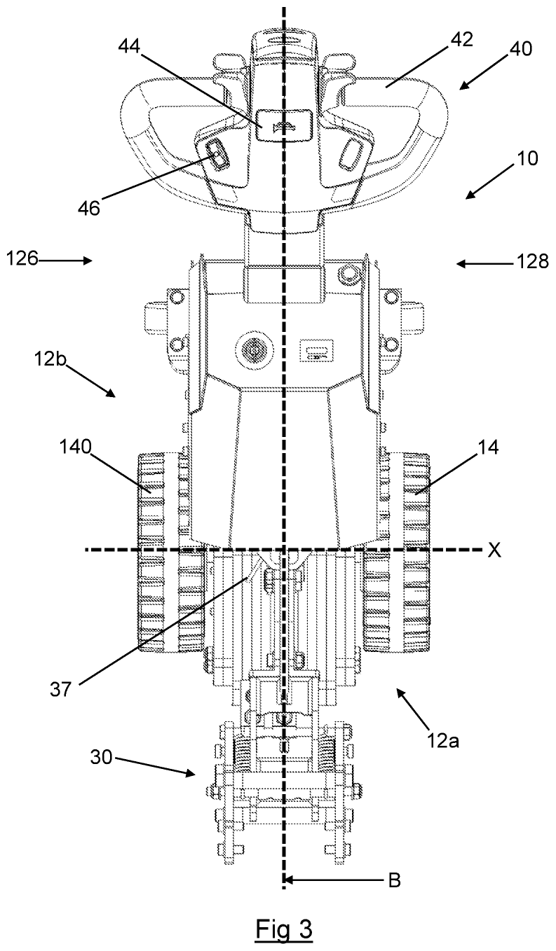

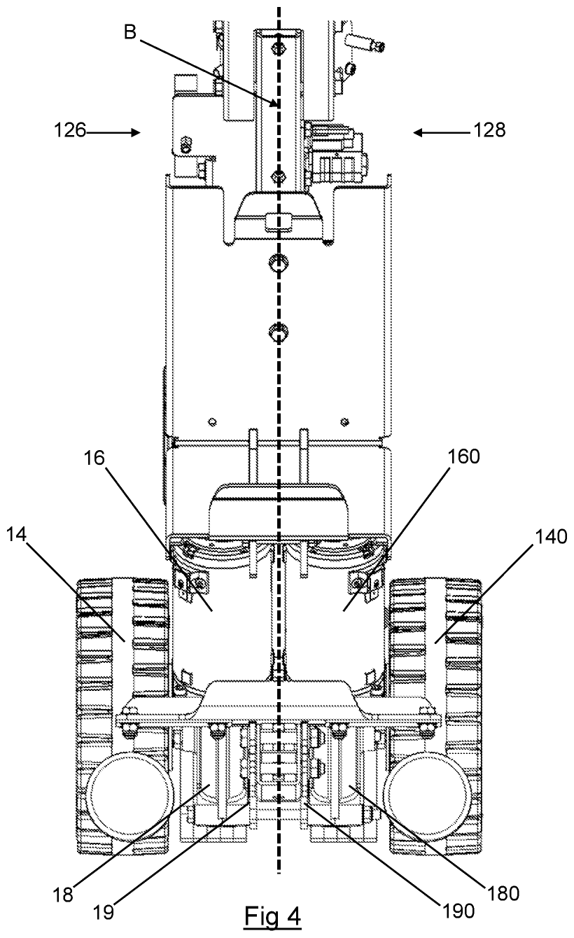

As shown in FIGS. 3 and 4, the main body 12 may be intersected by a substantially vertical plane B which is generally perpendicular to the vertical plane X. The main body 12 may have a first lateral side 126 generally arranged on one side of the plane B and a second lateral side 128 generally opposing the first lateral side 126 generally arranged on an opposite side of the plane B. In embodiments, the apparatus 10 and/or the main body 12 may be generally symmetrical about the plane B. The axis M of the main body 12 may lie on the plane B, as shown in FIGS. 3 and 4, i.e., the axis M may be perpendicular to the plane X. In embodiments, the axis M is inclined relative to a surface (e.g., the ground) when the apparatus 10 is in use, as shown in FIG. 2. In particular, the axis M may extend downwardly through the plane X as it extends from the second end 124 towards the first end 122.

The main body 12 may be inclined relative to a surface (e.g., the ground) when the apparatus 10 is in use. In other words, the main body 12, in use, may extend in a direction away from a surface (e.g., the ground) and rearwardly of the plane X. The main body 12 may extend in a direction away from one or more or all of: the at least one ground engaging device 14; the at least one drive member 16; the at least one transmission member 18; the at least one weight member; the load engagement device 30; and the castor wheel assembly 50. The castor wheel assembly 50 may be positioned underneath the main body 12 and rearwardly of the ground engaging device 14, as described in more detail below. In embodiments, the axis M may be oriented substantially parallel to, or perpendicular to, a surface over which the apparatus 10 is resting upon or moving across when the apparatus 10 is in use.

In embodiments, the main body 12 may support or otherwise include a housing 13 which, in use, at least partially covers components of the apparatus 10. The housing 13 may be releasably attached to the main body 12 to allow access to the components of the apparatus 10 for the purposes of repair and servicing.

In embodiments, the main body 12 may include a chassis member 11 which, in use, acts as a spine member for the apparatus 10. The chassis member 11 may be configured to receive or otherwise support components of the apparatus 10.

The ground engaging device 14 supports the main body 12 and assists in moving the main body 12 over a surface (e.g., the ground). In the present embodiment, the ground engaging device 14 is configured for rotation about an axis A. In use of the apparatus, the axis A is substantially horizontal, i.e., it may be substantially parallel with a surface over which the apparatus 10 is resting upon or moving across.

The ground engaging device 14 is operably connected to a transmission member 18. The transmission member 18 is also operably connected to a drive member 16. In use of the apparatus, the drive member 16 provides a source of drive power to the ground engaging device 14. The drive power provided by the drive member 16 is transmitted to the ground engaging device 14 by the transmission member 18.

In the present embodiment, the ground engaging device 14 is a wheel assembly. The wheel assembly includes a tyre mounted to a hub. The tyre of the wheel assembly may be manufactured from any suitable material. In one example, the tyre may be manufactured from a puncture-proof rubber material. In another example, the tyre may be manufactured from a rubber material that is non-marking when in contact with a surface. The tyre may also include a tread of any appropriate arrangement. The hub of the wheel assembly may be manufactured from any appropriate material, including a metal or a plastic. The selection of material may be based on the operational requirements of the apparatus 10. The hub of the wheel assembly is operably connected to a part of the transmission member 18. In embodiments, the hub is operably connected to a part of the transmission member 18 by the use of one or more fasteners. For example, the or each fastener may be a threaded bolt or other threaded fastener which passes through a corresponding hole in the hub, which subsequently engages with an appropriate formation provided on a part of the transmission member 18 or a corresponding threaded nut. Alternatively, the or each fastener may pass through a hole on a part of the transmission member 18 and engage with an appropriate formation provided on the hub or a corresponding threaded nut. A part of the transmission member 18 may include a formation which engages with a formation provided on the wheel hub. For example, this may comprise a spline or groove on a part of the transmission member which engages with a projection on the wheel assembly, or vice versa. The formations of the hub and transmission member 18 provide for rotation alignment between the two parts, whilst the axial alignment may be provided by a fastener or fasteners which secures the hub to the transmission member 18.

In the present embodiment, the transmission member 18 is a gearbox. In embodiments, other transmission members may be used, e.g., a pulley based or hydraulic system. The gearbox receives a rotational input from the drive member 16, and provides a rotational output which is transmitted to the ground engaging device 14. The gearbox may be arranged such that the rotational input and output are substantially aligned (i.e., the axes of rotation of the input and output are coincident), substantially parallel but offset by a non-specified distance, or substantially non-parallel such that an angle is formed between the rotational axes of the input and output. In embodiments, the axis of the rotational input of the gearbox is substantially perpendicular to the axis of the rotational output of the gearbox. The gearbox 18 may be a right-angle gearbox comprising a worm gear which is operably connected to the drive member 16, and the worm gear engages with a gear which is operably connected to the ground engaging device 14 (i.e., via a shaft or axle). The gear which is operably connected to the ground engaging device 14 may be generally coaxial with the axis A of the ground engaging device 14. The gear which is operably connected to the ground engaging device 14 may be a spur gear, a helical gear, or any other appropriate form of gear. In other embodiments, the worm gear may be operably connected to the ground engaging device 14, and the gear may be operably connected to the drive member 16. In embodiments, the transmission member 18 is supported on or by the main body 12. The transmission member 18 and corresponding ground engaging device 14 may be positioned at or close to the first end 122 of the main body 12.

In the present embodiment, the drive member 16 is a motor. The motor may be an electric motor, and may be a permanent magnet DC electric motor, brushless DC electric motor, AC electric motor or any other appropriate type of electric motor. The drive member 16 extends in a generally lengthwise direction, defining a main axis B. A rotating part of the drive member 16, for example a rotating shaft, is operably connected to the transmission member 18, such that rotation produced by the drive member 16 is transmitted to the ground engaging device 14. Rotation transmitted to the ground engaging device 14 causes the ground engaging device 14 to rotate about the substantially horizontal axis A. The rotating part of the motor engages, or otherwise cooperates, with the worm gear of the transmission member 18. In embodiments, the rotating part of the motor may be aligned with the main axis B.

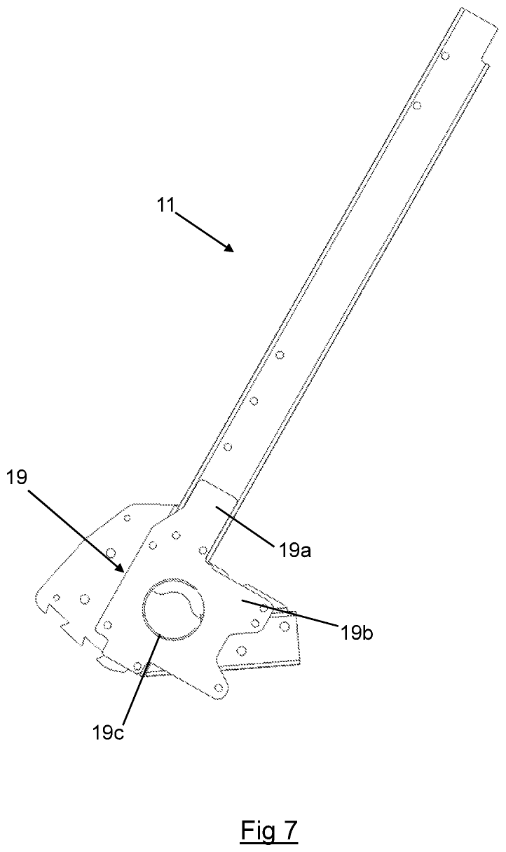

In embodiments, the apparatus 10 may also include an attachment member 19 for attaching the transmission member 18 to the main body 12. The attachment member 19 may be provided, attached, fixed or otherwise connected to the main body 12. In embodiments, the attachment member 19 may be provided, attached, fixed or otherwise connected to the chassis member 11. The attachment member 19 may be substantially planar. In embodiments, and as shown in FIG. 7, the attachment member 19 may include, at least, a first portion 19a and a second portion 19b. In use, the first portion 19a may extend in a direction which is substantially parallel to axis M of the main body 12. The second portion 19b may extend away from the first portion 19a. In particular, the second portion 19b may extend generally perpendicularly away from the first portion 19a. The second portion 19b may extend in a direction substantially parallel to the substantially vertical plane B. In embodiments, the attachment member 19 may also include a recess 19c for receipt of a portion of a transmission member 18. The recess 19c may be formed between the first and second portions 19a, 19b.

In use, the attachment member 19 may be attached to the apparatus 10, or chassis 11, when the apparatus 10 is in a first configuration, and the attachment member 19 may be detached from the apparatus 10, or chassis 11, when the apparatus 10 is in a second configuration, as described in more detail below.

In the present embodiment, and as shown in FIGS. 3 and 4, the apparatus 10 includes a further ground engaging device 140 in addition to the ground engaging device 14. The ground engaging device 14 is positioned on the first side 126 of the main body 12 and the further ground engaging device 140 is positioned on the second side 128 of the main body 12. The further ground engaging device 140 may be substantially the same as the ground engaging device 14. In embodiments the further ground engaging device 140 may be different to the ground engaging device 14. In embodiments, the further ground engaging device 140 may be positioned generally opposite the ground engaging device 14. The further ground engaging device 140 may be positioned such that the ground engaging device and further ground engaging device rotate about a common or shared substantially horizontal axis A. In embodiments the ground engaging device and further ground engaging device may rotate about different axes.

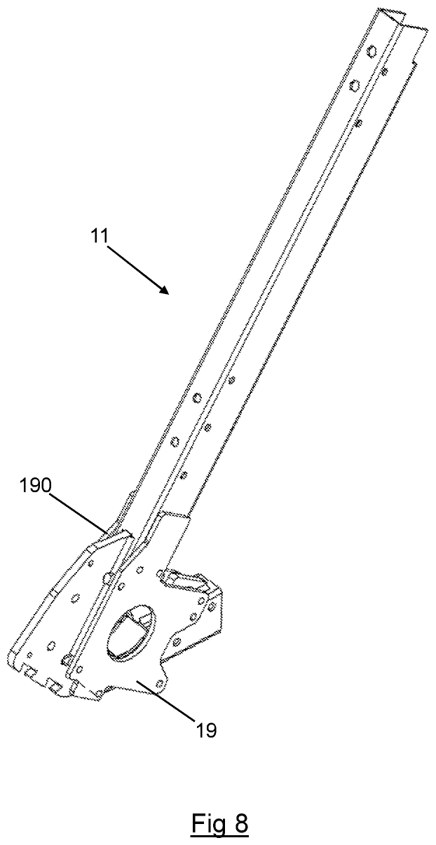

In the present embodiment, the apparatus also includes a further drive member 160 and a further transmission member 180, as shown in FIGS. 3 and 4. In embodiments, the apparatus 10 may also include a further attachment member 190, as shown in FIG. 8. The further drive member 160 is operably connected to the further transmission member 180, and the further transmission member 180 is operably connected to the further ground engaging device 140. The operable connections may be similar, or substantially identical, to the operable connections between the drive member 16, transmission member 18 and ground engaging device 14 described above. In embodiments, the drive member 16 and transmission member 18, and the attachment member 19 if present, are positioned on the first side 126 of the main body 12, and the further drive member 160 and a further transmission member 180, and the further attachment member 190 if present, are positioned on the second side 128 of the main body 12.

In other embodiments, the apparatus 10 may not include a further drive member 160 and further transmission member 180. In embodiments the ground engaging device 14 and further ground engaging device 140 may be operably connected to a single transmission member 18 which is operably connected to a single driver member 16, such that the ground engaging device 14 and further ground engaging device 140 are driven by a single drive member 16.

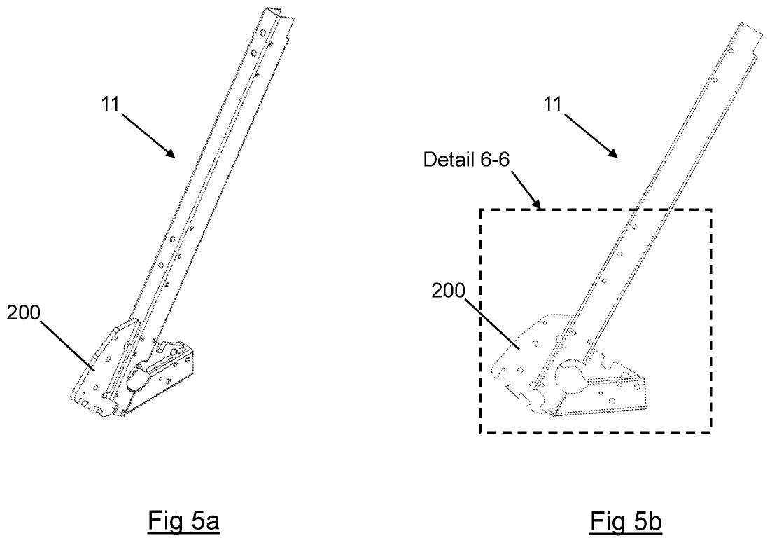

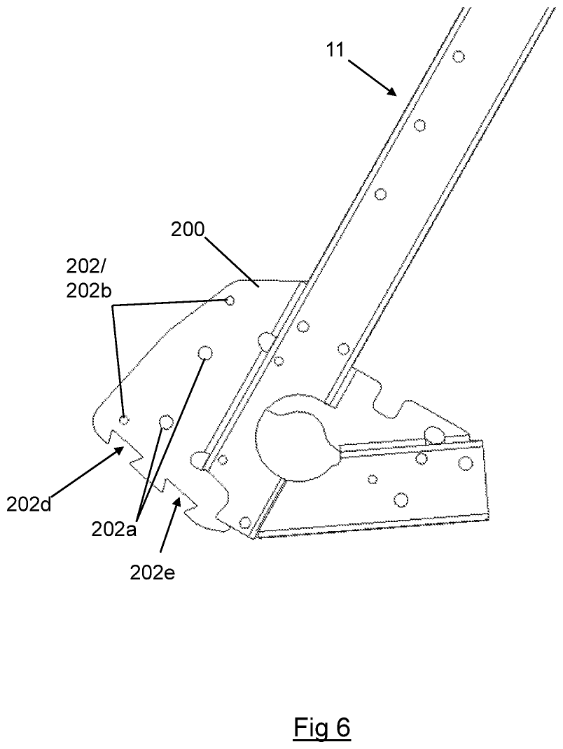

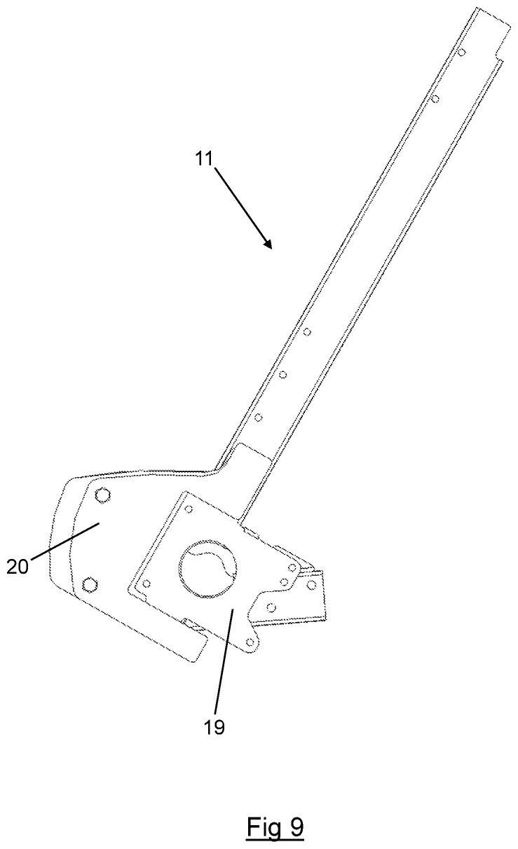

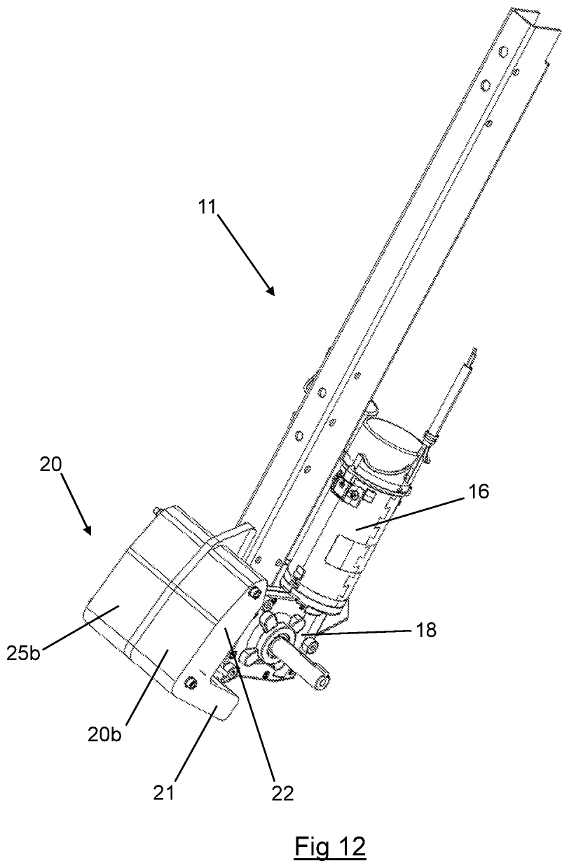

In embodiments, and as shown in FIGS. 5a-5b and 6, the apparatus 10 may further include a weight member receiving portion 200 for fixing a weight member 20 thereto. The apparatus 10 may be configured such that it is able to adopt either of first or second respective configurations. In the first configuration, a first weight member 20a is receivable by the receiving portion 200 (as shown in FIGS. 9 to 11 at least). In the second configuration, a second weight member 20b is receivable the receiving portion 200 (as shown in FIG. 12). In embodiments, the first weight member 20a may be different to the second weight member 20b. The first weight member 20a may differ from the second weight member 20b by any of the following attributes of the weight member 20 including, but not limited to, the mass, size, volume, shape, construction, material, colour and/or fixing means. In embodiments, the first or second weight member may be formed from a material, or materials, comprising cast iron and/or a steel alloy. The first and/or second weight member 20a, 20b may include first and second respective portions 21, 22 and, in particular, may be substantially L-shaped or U-shaped, as described in more detail below.

In embodiments, the weight member receiving portion 200 may be supported on or by the main body 12. The weight member receiving portion 200 may be positioned at or close to the first end 122 of the main body 12. In embodiments, the weight member receiving portion 200 may be provided on a part of the chassis member 11 of the main body 12, which may be positioned at or close to the first end 122 of the main body 12. However, it should be appreciated that the weight member receiving portion 200 may be provided on another part of the main body 12. In embodiments, the first or second weight member 20a, 20b may be received by the weight member receiving portion 200 such that it is positioned on the first lateral side 126 of the main body 12. In embodiments, the first or second weight member 20a, 20b may be received by the weight member receiving portion 200 such that it is positioned on the second lateral side 128 of the main body 12.

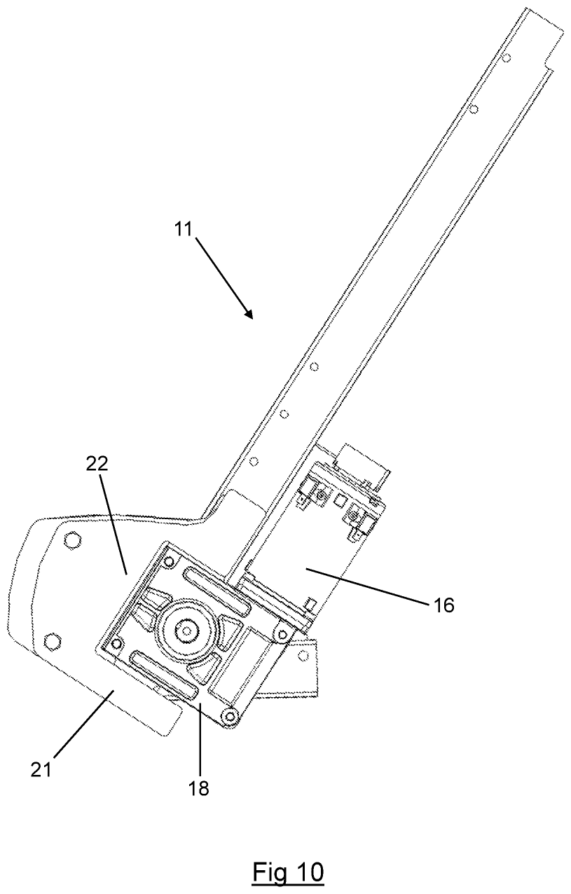

In use, a weight member 20 may be fixed to the weight receiving portion 200, as shown in FIGS. 10 to 12. The weight member receiving portion 200 may include at least one receiving formation 202 which facilitates fixing the first or second weight member 20a, 20b to the weight receiving portion 200. In embodiments, the receiving formation 202 may comprise at least one aperture for receiving a fastener. The aperture may be configured to allow a fastener to pass through the aperture, or it may be at least partially threaded such that it can engage with a part of a fastener. In embodiments, the receiving formation 202 may also, or alternatively, comprise a shaped formation which engages with a complementary formation provided on the weight member 20.

In embodiments, the weight member receiving portion 200 may include a plurality of receiving formations 202 for receiving a part of the first and/or second weight members 20a, 20b. A part of a weight member 20a, 20b received by the receiving formations 202 may include an integral part of the weight member 20a, 20b, a part that is connected to the weight member 20a, 20b, or a fastener which is provided with the weight member 20a, 20b. In embodiments, the plurality of receiving formations 202 includes a first formation 202a for receiving a part of a first weight member 20a, and a second formation 202b for receiving a part of a first weight member 20b. The first formation 202a for receiving a part of the first weight member 20a may include at least one aperture as described above. The second formation 202b for receiving a part of the second weight member 20b may include at least on aperture as described above.

In embodiments, the first formation 202a may include a plurality of apertures and/or may include a plurality of shaped formations, e.g. a projection which extends into an aperture in use, which engage with complementary formations provided on the first weight member 20a. The plurality of apertures may receive a part of a fastener, e.g., a bolt, as described in more detail below. Alternatively, the first receiving formation 202a may include a part which protrudes from the weight receiving portion 200 which may engage with a complementary formation or aperture provided on the first weight member 20a. The second formation 202b may include a plurality of apertures and/or may include a plurality of shaped formations which engage with complementary formations provided on the second weight member 20b. The plurality of apertures may receive a part of a fastener, as described in more detail below. Alternatively, the first receiving formation 202a may include a part which protrudes from the weight receiving portion 200 which may engage with a complementary formation or aperture provided on the first weight member 20a.

In embodiments, the first formation 202a may comprise a plurality of apertures and/or shaped formations which are different to the plurality of apertures and/or shaped formations of the second formation 202b. When the apparatus 10 adopts a first configuration, the weight member receiving portion 200 may be in a first configuration in which the first formation 202a is used to fix, attach or otherwise support the first weight member 20a on the main body 12. In the present embodiment, and as shown in FIG. 6, the first formation 202a comprises two apertures. When the apparatus 10 adopts a second configuration, the weight member receiving portion 200 may be in a second configuration in which the second formation 202b is used to fix, attach or otherwise support the second weight member 20b on the main body 12. In the present embodiment, and as shown in FIG. 6, the second formation 202b comprises two apertures.

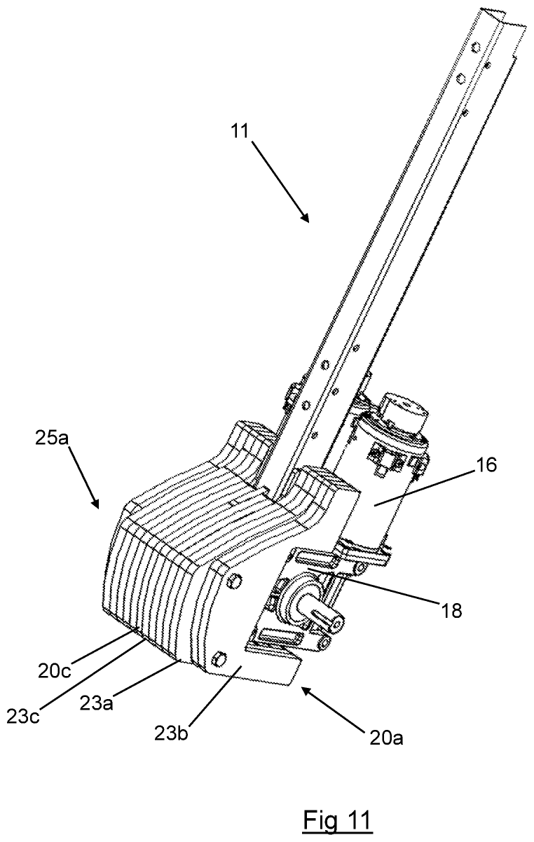

A first configuration of the apparatus 10 is shown in FIG. 11, wherein a first weight member 20a is received by the weight receiving portion 200, and wherein a part of the first weight member 20a is received by the first receiving formation 202a. In embodiments, the part of the first weight member 20a received by the first receiving formation 202a may comprise at least one fastener provided with the first weight member 20a. The fastener may be a threaded bolt or screw which may engage the first receiving formation 202a. Alternatively, the fastener may pass through the first receiving formation 202a and may engage with a complementary nut or other suitable component which may engage with the thread of a fastener. However, it should be appreciated that the first receiving formation 202a may receive a part of the first weight member 20a which is permanently attached to the first weight member 20a or is formed as an integral part of the first weight member 20a. In this first configuration, an attachment member 19 may be attached to the main body 12 for receipt of a transmission member 18.

A second configuration of the apparatus 10 is shown in FIG. 12, wherein a second weight member 20b is received by the weight receiving portion 200, and wherein a part of the second weight member 20b is received by the second receiving formation 202b. In embodiments, the part of the second weight member 20b received by the second receiving formation 202b may comprise at least one fastener provided with the second weight member 20b. The fastener of the second weight member 20b may be similar to, or substantially identical, to the fastener of the first weight member 20a. In embodiments, the second weight receiving formation 202b may comprise a fastener of a different type to that of the first weight receiving formation 202a. However, it should be appreciated that the second receiving formation 202b may receive a part of the second weight member 20b which is permanently attached to the second weight member 20b, or is formed as an integral part of the second weight member 20b. In this second configuration, an attachment member 19 may be detached from the main body 12.

Advantageously, as the weight member receiving portion 200 may receive at least a first weight member 20a in a first configuration of the apparatus 10 and a second weight member 20b in a second configuration of the apparatus 10, the apparatus 10 may be provided such that the mass, or other attributes relating to the weight members 20a, 20b, of the apparatus 10 is different in each configuration. This enables the performance of the apparatus 10 to be optimised depending on the desired operational requirements of the apparatus 10. In addition, the performance of the apparatus 10 may be optimised depending on the type of ground engaging device 14, drive member 16 and/or transmission member 18 which may be supported on or by the main body 12. The optimisation of the mass and other attributes relating to the weight member 20a, 20b of the apparatus 10 ensures that the apparatus 10 performs efficiently and without excess power consumption.

In embodiments, the first and/or second weight member 20a, 20b may include at least a first portion 21 and a second portion 22. As shown in FIGS. 10 to 12, the first portion 21 may be generally inclined at an angle relative to the second portion 22. In embodiments, the first portion 21 and second portion 22 may be substantially parallel, or substantially perpendicular. The first and second portions 21, 22 of the first and/or second weight member 20a, 20b may be of a unitary construction. In embodiments, the first and second portions 21, 22 of the first and/or second weight member 20a, 20b may be formed as discrete weight members and may each be separately connected, fixed, or otherwise supported by the weight member receiving portion 200. In embodiments, the first and second portions 21, 22 may form a weight member 20 which is substantially L-shaped or U-shaped. In embodiments, the first and second portions 21, 22 may form a weight member 20 of other shapes.

As shown in FIG. 10, the first and/or second portions 21, 22 of the first or second weight member 20a, 20b may be positioned such that the weight member at least partially surrounds the substantially horizontal axis A of the ground engaging device 14. In use, the first and/or second portions 21, 22 may be positioned or at least partially extend in any of the following orientations with respect to the axis A of the ground engaging device 14: below the axis A; and/or above the axis A; and/or forwardly of the axis A; and/or rearwardly of the axis A. As shown in FIG. 10, in use, the first and/or second weight member 20a, 20b may be positioned such that the first and/or second portions 21, 22 may extends at least partially around the transmission member 18. In embodiments, the shape of a part of the of the first and/or second weight member 20a, 20b may be formed such that it is complementary to the shape of a part of the transmission member 18.

It is desirable, for optimum performance of the apparatus 10 in use, for the centre of mass of the apparatus 10 to be close to a ground surface, and to be close to the axis A of the ground engaging device 14. Positioning the weight member 20 such that, in use, it may surround the axis A enables the position of the centre of mass of the weight member 20, and as a result the centre of mass of the apparatus 10, to be optimised relative to the axis A to provide optimal tractive force between the ground engaging device 14 and a ground surface. This is particularly beneficial in configurations of the apparatus 10 in which a different ground engaging device 14, drive member 16, transmission member 18, or any other component of the apparatus 10 is supported on or by the main body 12 which cause the centre of mass to be shifted relative to a different configuration.

In embodiments, the first and/or second weight member 20a, 20b may be formed from a plurality of sheets 23. In embodiments, the sheets may be substantially planar. However, it should be appreciated that the sheets may be curved, bent, or shaped in any other appropriate form.

As shown in FIG. 11, the plurality of sheets 23 may include a first sheet 23a, a second sheet 23b and a third sheet 23c. In embodiments, the first sheet 23a may have a first shape, the second sheet 23b may have a second shape and/or the third sheet 23c may have a third shape. The first shape may be different to the second shape. The third shape may be different to the first and/or second shapes. In embodiments, the plurality of sheets 23 may include a plurality of first sheets 23a and/or a plurality of second sheets 23b and/or a plurality of third sheets 23c. In embodiments, the plurality of sheets 23 may include additional sheets having a shape which is different to the first shape and/or second shape and/or third shape. For example, the plurality of sheets 23 may include four or more different sheet shapes. Forming the first and/or second weight member 20a, 20b from a plurality of sheets 23 enables an optimal number of sheets to be selected depending on the operating requirements of the apparatus 10. In addition, forming the first and/or second weight member 20a, 20b from a plurality of sheets 23 of different shapes enables the three-dimensional shape or profile of the weight member to be optimised such that it may avoid contacting other moving and/or non-moving components of the apparatus, such as the rotatably moveable load engagement device 30 described in more detail below.

In embodiments, the apparatus 10 may include a further first and/or second weight member 25a, 25b. The further first and/or second weight member 25a, 25b may be received by the receiving portion 200. The further first and/or second weight member 25a, 25b may be similar to, or substantially the same as, a corresponding first and/or second weight member 20a, 20b. However, it should be appreciated that the further first and/or second weight member 25a, 25b may be different to a corresponding first and/or second weight member 20a, 20b. As shown in FIGS. 11 and 12, the first or second weight member 20a, 20b may be received by the weight member receiving portion 200 on the first lateral side 126 of the main body 12. The other of the first or second weight member 20a, 20b may be received by the weight member receiving portion 200 on the second lateral side 128 of the main body 12.

The apparatus may include a further, fourth, weight member 20c. The fourth weight member, in use, may be positioned between the first weight member 20a and further first weight member 25a, or second weight member 20b and further second weight member 25b. The fourth weight member 20c may be formed as a sheet. The fourth weight member 20c may have a fourth shape which is different to the first and/or second and/or third shapes. The fourth weight member 20c may be formed of substantially the same material as the first and/or second weight member 20a, 20b. The fourth weight member 20c may be received by a portion of the weight member receiving portion 200. In particular, the fourth weight member 20c may be received by first and second recesses, 202d, e of the weight member receiving portion 200.

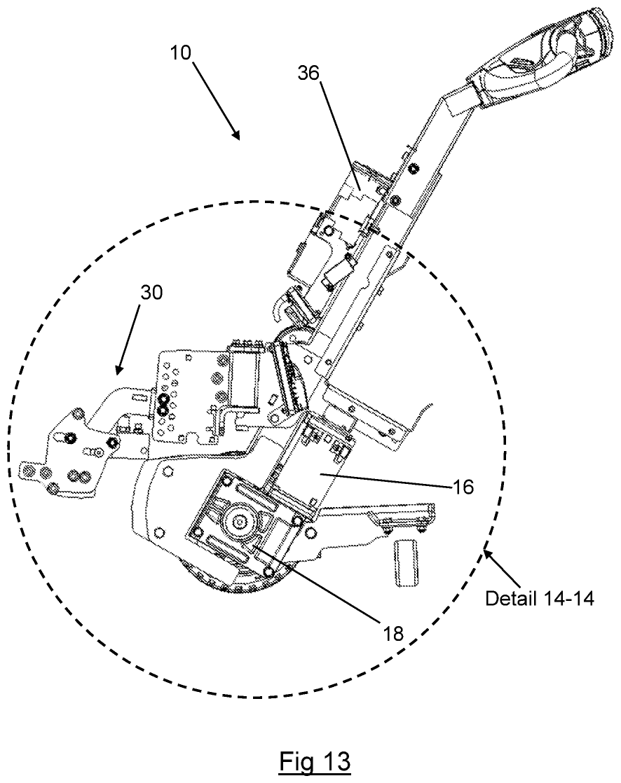

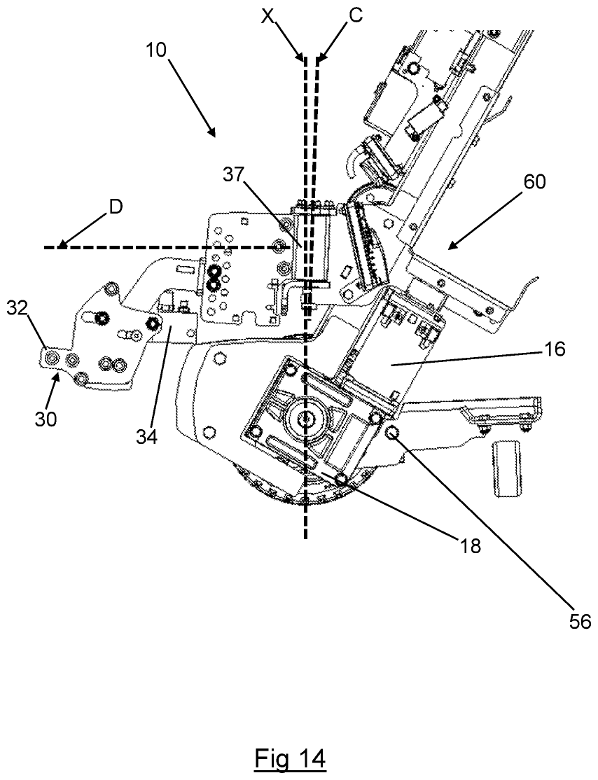

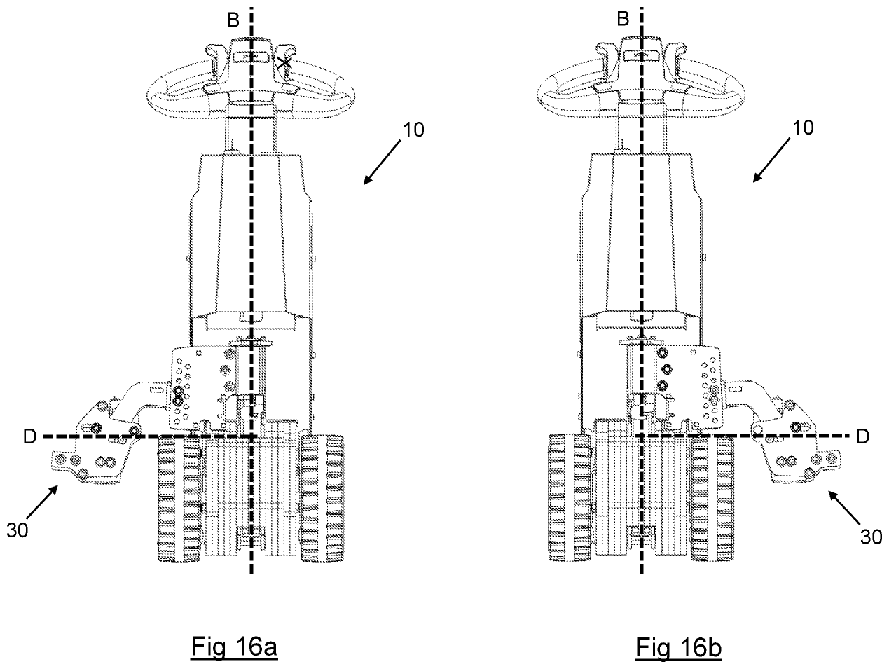

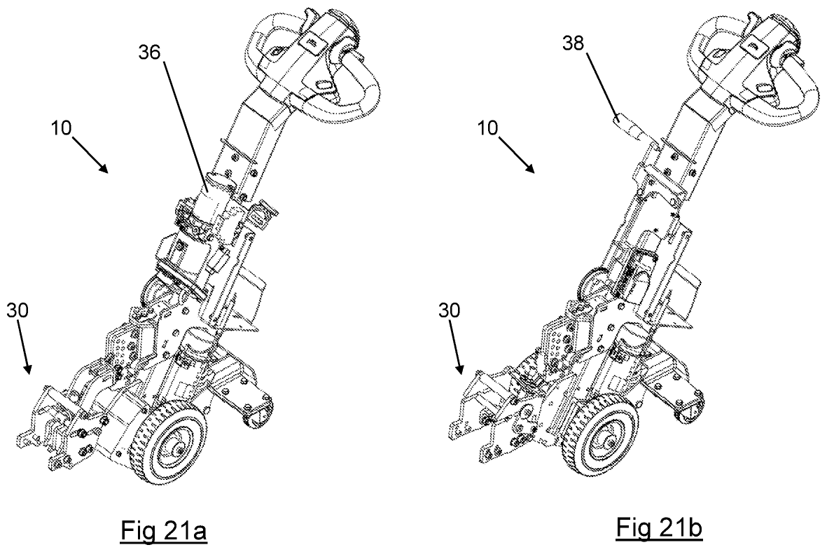

In embodiments, and with reference to FIGS. 13 to 16b in particular, the apparatus 10 may include a load engagement device 30. In use, the device 30 may abut with, engage with or grasp a part of a load to be moved. The load engagement device 30 may include at least one engagement member 32 which engages with or grasps a part of a load to be moved. The at least one engagement member 32 may be moveable between a first position in which the member 32 is engaged with a part of a load to be moved, and a second position in which the member 32 is disengaged from a part of a load to be moved. The at least one engagement member 32 may be operably connected to an actuation member 34, which effects the movement of the engagement member 32 between the first and second positions. The actuator member 34 may be an electrical actuator, or it may be a hydraulic actuator such as an electrohydraulic actuator, or it may be a cable-actuated actuator such as a Bowden cable type actuator. In embodiments, and as shown in FIGS. 21a-b, the source of hydraulic power for an electrohydraulic actuator, such as a pump 36 and/or an accumulator (not shown), or a cable mechanism 38, for example a Bowden cable mechanism, for a cable-actuated actuator may be supported on or by the main body 12. The load engagement device 30 is supported on or by the main body and is positioned in or adjacent to the front portion 12a of the main body 12.

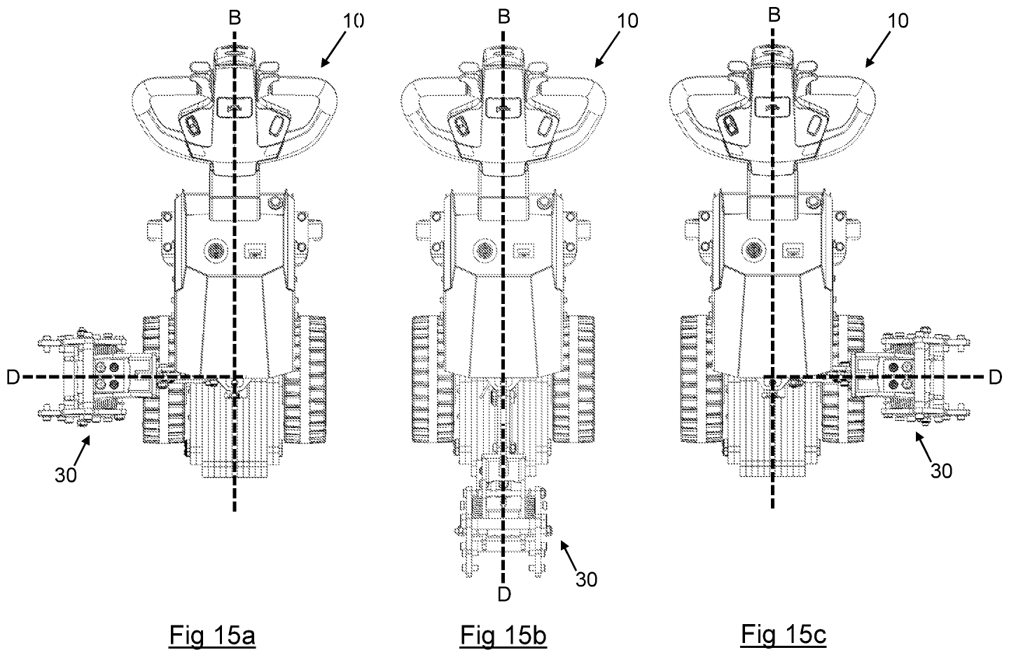

In embodiments, the load engagement device 30 is rotatably mounted to the main body 12, and is configured to rotate about an axis C. In embodiments, the axis C may be substantially parallel with the vertical plane X, may lie on the plane X, or may intersect the vertical plane X. The axis C may be positioned substantially perpendicular to, the axis A of the ground engaging device 14. As shown in FIGS. 13 to 16b, the load engagement device 30 may extend along an axis D, e.g., in a direction away from the main body 12. In particular, the axis D, in a ready to use condition of the apparatus 10, may lie on the plane B. The load engagement device 30 may be rotatably movable in a clockwise and anti-clockwise direction. The load engagement device 30 may be rotatable between a first position where the axis D is substantially perpendicular to the horizontal axis A of the ground engaging device 14 and/or the vertical plane X intersecting the main body 12, and a second position whereby the axis D is oriented at a non-perpendicular angle to the horizontal axis A. In the second position, the axis D may be parallel to, or coaxial with, the horizontal axis A. As shown in FIGS. 15a-c and 16a-b, the load engagement device 30 may thus be movable through 180 degrees of motion relative to the main body 12. In the second position the load engagement device 30 may be positioned on the first side 126 of the apparatus 10, and substantially adjacent the ground engaging device 14. The load engagement device 30 may then be rotated 180 degrees about the axis C to a third position, such that it is positioned on the second side 128, and substantially adjacent the further ground engaging device 140. The load engagement device 30 may also include a biasing member 37, which in use biases the load engagement 30 device towards the first position. The biasing member 37 may, in one example, be a torsion spring.

Advantageously, when the first and/or second weight member 20a, 20b is formed from a plurality of sheets 23 having different shapes, the three-dimensional shape or profile of the first and/or second weight member 20a, 20b may be optimised such that the load engaging device can rotate between the first and second positions and be moved through 180 degrees of rotational motion unimpeded, and will not make contact with any part of the first and/or second weight member 20a, 20b.

The apparatus 10 can be operated by a pedestrian. In embodiments, the apparatus 10 may include a user graspable handle 40, which allows a pedestrian to operate the apparatus 10 for the purposes of movement and steering over a ground surface in addition to other functions such as operating other parts of the apparatus 10. The user graspable handle 40 is supported on or by the main body 12, The user graspable handle 40 is connected towards the second end 124 of the main body 12 and positioned in or adjacent to the rear portion 12b of the main body 12. The user graspable handle 40 is positioned generally above the at least one ground engaging device 14, the at least one drive member 16, the at least one transmission member 18 and the load engaging device 30. The user graspable handle 40 may be formed of a material which is similar or dissimilar to the material of the main body 12, which may comprise a plastic and/or metal material. The user graspable handle 40 may be connected to the main body 12 by the use of a fastener or fasteners, may engage with a formation provided on the main body 12, may be permanently fixed to the main body 12, or may be formed integrally with a part of the main body 12. The user graspable handle 40 includes at least one user graspable part 42 at an upper free end, a portion of which may comprise a material which is comfortable for an operator to grasp, such as a rubber material, soft plastic material, or any other suitable material.

The apparatus 10 may include at least one alerting device 44, which may be operable by the operator. The at least one alerting device 44 may be positioned on the user graspable handle 40. The at least one alerting device 44 may be configured to produce an audible warning signal and/or a visual signal.

The apparatus 10 may include an operating device 46, which allows the operator to control a function of the apparatus 10, such as operation of the load engagement device 30 or any other appropriate function. The operating device 46 may be positioned on the user graspable handle 40. In embodiments, the load moving apparatus 10 may be configured to be controlled from a remote device such that a pedestrian operator may be spaced at a distance from the apparatus 10 to move or otherwise operate the apparatus. In such embodiments, the apparatus 10 may include a user graspable handle 40 such that the operator may operate the apparatus 10 manually or remotely as desired.

In embodiments, the apparatus 10 may include a castor wheel assembly 50. The castor wheel assembly is positioned in or adjacent to the rear portion 12b of the main body 12. The castor wheel assembly 50 includes a castor arm 52 and at least one castor 54 which is connected to the castor arm. The castor arm 52 is connected at a first end 52a to the main body 12, and may be rotatably connected to the main body 12 such that it is rotatably moveable with respect to the main body 12 between a first and second position. In embodiments, the castor arm 52 may be connected to the main body 12 such that it remains in a fixed position. The at least one castor 54 includes a wheel portion 54a which is supported by, and is rotatably moveable relative to, a mounting portion 54b. The at least one castor 54 is mounted at or close to a second end 52b of the castor arm 52 via the mounting portion 54b. The at least one castor 54 may be configured such that, in use, the mounting portion 54b is able to swivel about a substantially vertical axis whilst permitting the wheel portion 54a to rotate. In embodiments, the castor wheel assembly 50 may also include a castor arm biasing member 56 which, in use, urges the castor arm 52 towards the first or second position. The castor arm biasing member 56 is connected at one end to a part of the castor arm 52 and is connected to a part of the main body 12 at another end. The castor arm biasing member 56 may comprise a coil spring or any other suitable biasing mechanism.

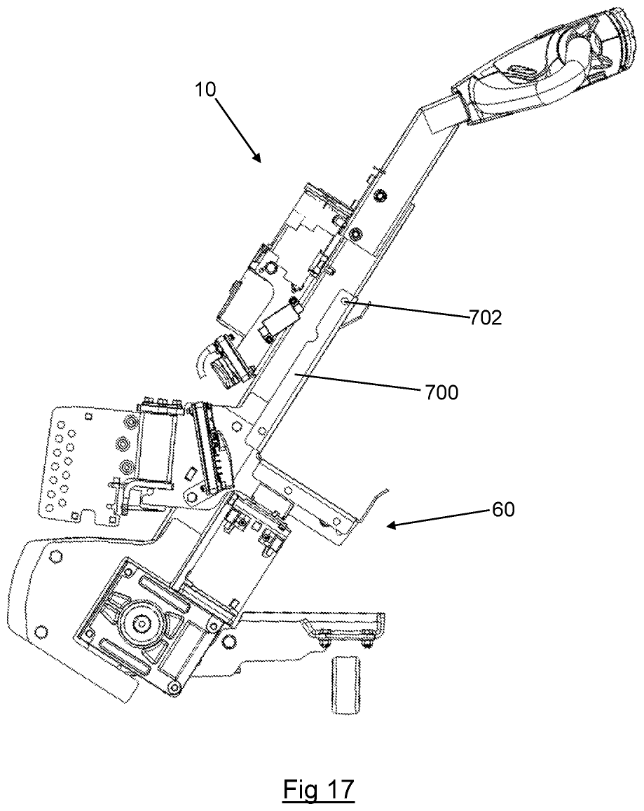

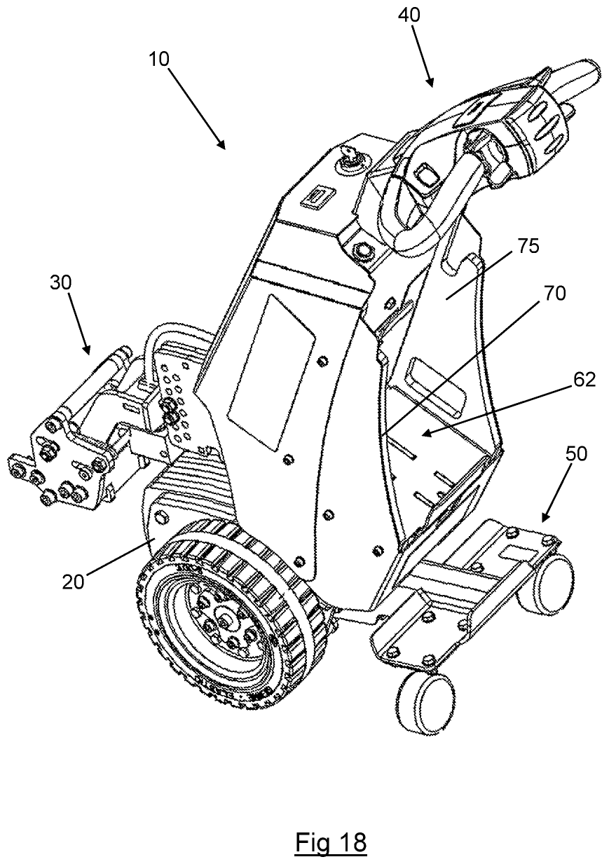

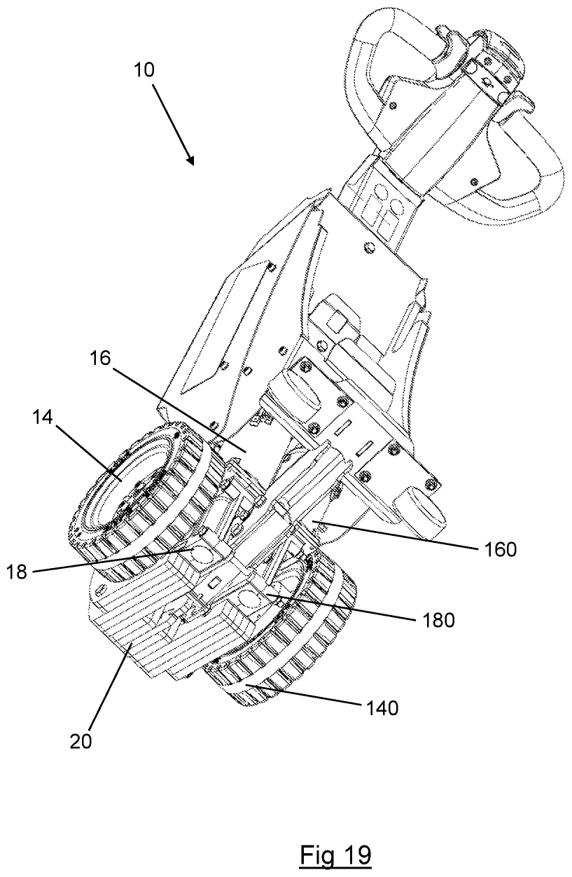

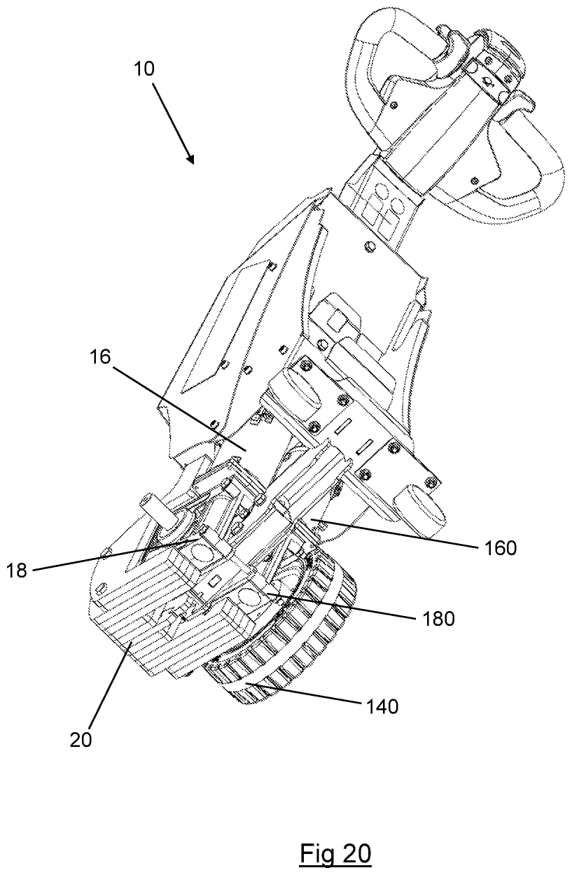

In embodiments, the apparatus 10 includes a power receptacle 60, as shown in FIGS. 17 to 20. In some embodiments, the power receptacle 60 may be a socket or port which may receive a cable from an external power source, such as a source of mains electricity or a generator. In embodiments, the power receptacle 60 may be a battery compartment 62 configured to receive an insertable battery device. The battery received by the receptacle 60 may be a rechargeable battery, and may be a lead acid battery, a nickel metal hydride battery, a lithium-ion battery or a nickel cadmium battery. In use, the power receptacle is operably connected to the at least one drive member 16, and may be operably connected to other components of the apparatus 10, such as devices provided on the user graspable handle 40, which require a source of power to operate. In embodiments wherein a battery is received by the power receptacle 60, the operating characteristics of the battery, such as capacity, voltage, power, energy density and type may be selected based on the requirements of the apparatus 10.

The apparatus 10 may also include a further receiving portion 700 for receiving a third weight member 70. In use of the apparatus 10, the further receiving portion 700 may be positioned substantially above the weight member receiving portion 200. In embodiments, it may be positioned substantially to the rear of the weight member receiving portion 200. The further receiving portion 700 may also be positioned substantially above and/or substantially to the rear of the ground engaging device 14, drive member 16 and transmission member 18. The further receiving portion 700 may also be positioned in the rear portion 12b of the main body 12, and substantially rearwardly of the vertical plane X.

As shown in FIG. 17, the battery compartment 62 may include the further receiving portion 700. In embodiments, the further receiving portion 700 could be provided on another component of the apparatus 10 or on the main body 12 and/or chassis member 11 of the apparatus 10. As shown in FIG. 17, a portion of the further receiving portion 700 may extend in a direction away from the first end 122 of the main body 12. A portion of the further receiving portion 700 may extend in a direction generally perpendicular to the axis M of the main body 12. The further receiving portion 700 may also extend in a direction substantially parallel to the plane B which intersects the main body 12.

In embodiments, the further receiving portion 700 may include a receiving formation 702 which facilitates fixing the third weight member 70 to the further receiving portion 200. In embodiments, the receiving formation 702 may comprise at least one aperture for receiving a fastener. The aperture may be configured to allow a fastener to pass through the aperture, or it may be at least partially threaded such that it can engage with a part of a fastener. In embodiments, the receiving formation 702 may also, or alternatively, comprise a shaped formation which engages with a complementary formation provided on the third weight member 70.

The third weight member 70 may be similar to, or substantially the same as, the first or second weight member 20a, 20b. In embodiments, the third weight member 70 may be different to the first or second weight member 20a, 20b. The third weight member 70 may share one, or a plurality of, common attribute(s) with the first or second weight member 20a, 20b, including, but not limited to, the mass, size, volume, shape, construction, material, colour and/or fixing means.

In use of the apparatus 10, the third weight member 70 may be received by the further receiving portion 700 such that the third weight member 70 is positioned adjacent a battery device which is received by the battery compartment 62.

In embodiments, the third weight member 70 may be received by the further receiving portion 700 such that the third weight member 70 is positioned on the first lateral side 126 of the main body 12. In use, positioning third weight member 70 on the first lateral side of the main body 12 means that the third weight member 70 may also be placed on a first lateral side of the battery device 62. In embodiments, the third weight member 70 may be received by the further receiving portion 700 such that the third weight member 70 is positioned on the second lateral side 128 of the main body 12. In use, positioning third weight member 70 on the second lateral side 128 of the main body 12 means that the third weight member 70 may also be placed on a first lateral side of the battery device 62.

In embodiments, the apparatus may include a further third weight member 75. The further third weight member 75 may also be received by the further receiving portion 700. The further third weight member 75 may be similar to, or substantially the same as, the third weight member 70. In embodiments, the further third weight member 75 may be different to the third weight member 70. The further third weight member 75 may share one, or a plurality of, common attribute(s) with the third weight member 70, including, but not limited to, the mass, size, volume, shape, construction, material, colour and/or fixing means.

In embodiments, the third weight member 70 may be received by the further receiving portion 700 such that the third weight member 70 is positioned on the first lateral side 126 of the main body 12. The further third weight member 75 may be received by the further receiving portion 700 such that the further third weight member 75 is positioned on the second lateral side 128 of the main body 12. In use, this positioning of the third weight member 70 and the further third weight member 75 means that the weight members 70, 75 are positioned on either lateral side lateral side of the battery device 62.

Advantageously, providing a further receiving portion 700 for receiving a third weight member 70 enables more mass to be added to the apparatus 10, particularly when no further mass can be added to the weight member receiving portion 200 provided at or close to the first end 122 of the main body 12. In addition, the positioning of the further receiving portion 700 closer towards the second end 124 of the main body 12 relative to the weight member receiving portion 200 enables the weight distribution, and/or the location of the centre of mass, of the apparatus 10 to be modified and/or optimised depending on operational requirements of the apparatus 10, leading to improvements in energy efficiency of the apparatus 10.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

What is claimed is:

1.-25. (canceled)

26. A load moving apparatus including:
a main body having a receiving portion for receiving a weight member;
at least one ground engaging device supported on or by the main body;
wherein the apparatus is configured to adopt either of first or second respective configurations; wherein in the first configuration a first weight member is receivable by the receiving portion, and in the second configuration a second weight member is receivable by the receiving portion, and wherein the first weight member is different to the second weight member.

27. The load moving apparatus of claim 26, wherein the main body includes a first end and a second end, and wherein the at least one ground engaging device is positioned at or close to the first end;
wherein the receiving portion is positioned at or close to the first end of the main body.

28. The load moving apparatus of claim 26, wherein the main body includes a first lateral side and a second lateral side, and the main body is intersected by a substantially vertical plane B, said plane B positioned between the first and second lateral sides of the main body;
wherein the first or second weight member is receivable by the receiving portion on the first lateral side; and/or
wherein a further first or further second weight member is receivable by the receiving portion on the second lateral side.

29. The load moving apparatus of claim 28 including a first weight member received by the receiving portion;
wherein the first weight member includes first and second portions;
wherein the first portion is inclined relative to the second portion; and
wherein the at least one ground engaging device is configured for rotation about a substantially horizontal axis A, and, in use, the first and/or second portion of the first or second weight member is at least partially positioned or extends:
a) below the axis A; and/or
b) above the axis A; and/or
c) forwardly of the axis A; and/or
d) rearwardly of the axis A.

30. The load moving apparatus of claim 29, wherein the first weight member comprises a cast iron and/or a steel alloy.

31. The load moving apparatus of claim 29, wherein the first weight member is formed from a plurality of sheets;
wherein the plurality of sheets includes a first sheet and a second sheet;
wherein the first sheet has a first shape and the second sheet has a second shape, wherein the second shape is different to the first shape.

32. The load moving apparatus of claim 29 including a further first weight member received by the receiving portion.

33. The load moving apparatus of claim 32, wherein the first weight member is received by the receiving portion on the first lateral side and the further first weight member is received by the receiving portion on the second lateral side.

34. The load moving apparatus of claim 26, wherein in the first configuration the receiving portion is in a first configuration; and
wherein in the second configuration the receiving portion is in a second configuration.

35. The load moving apparatus of claim 26, wherein the receiving portion includes at least one receiving formation for receiving a part of a first and/or second weight member;
wherein the receiving portion includes a plurality of receiving formations for receiving a part of the first and/or second weight members;
wherein the plurality of receiving formations includes a first formation for receiving a part of a first weight member, and a second formation for receiving a part of a second weight member;
wherein the first formation for receiving a part of the first weight member includes at least one aperture, and/or the second formation for receiving a part of the second weight member includes at least one aperture, and wherein the at least one aperture of the first and/or second formation is at least partially threaded.

36. The load moving apparatus of claim 28, wherein the main body includes a further receiving portion, and a third weight member is receivable by the further receiving portion;
wherein the further receiving portion for receiving a third weight member extends away from the first end of the main body;
wherein the further receiving portion extends in a direction generally perpendicular to an axis of the main body; and/or
wherein the further receiving portion extends in a direction substantially parallel to a plane B which intersects the main body.

37. The load moving apparatus of claim 28 further including:
a drive member for driving the at least one ground engaging device; and
at least one transmission member operably connected to the drive member and the ground engaging device for transmitting drive from the drive member to the ground engaging device for rotating the device about a or the axis A.

38. A load moving apparatus according to claim 37 including:
an attachment member for attaching the at least one transmission member to the main body; wherein in the first configuration the attachment member is attached to the main body; and
wherein in the second configuration the attachment member is detached from the main body;
a further ground engaging device;
a further drive member for driving the further ground engaging device; and
a further transmission member operably connected to the further drive member and the further ground engaging device for transmitting drive from the further drive member to the further ground engaging device;
a further attachment member for attaching the further transmission member to the main body;
wherein the ground engaging device, drive member and transmission member are positioned to the first lateral side and the further ground engaging device, further drive member and further transmission member are positioned to the second lateral side;
wherein the attachment member is positioned on the first lateral side, wherein the transmission member is receivable at least partially by the attachment member; and
wherein the further attachment member is positioned on the second lateral side, wherein the further transmission member is receivable at least partially by the second attachment portion.

39. The load moving apparatus of claim 37 including a first weight member received by the receiving portion;
wherein the first weight member extends at least partially around the transmission member.

40. The load moving apparatus of claim 37 including a third weight member wherein the third weight member is received by a further receiving portion;
wherein the third weight member includes first and second portions;
wherein the first portion is inclined relative to the second portion; and
wherein the at least one ground engaging device is configured for rotation about a substantially horizontal axis A, and, in use, the first and/or second portion of the third or second weight member is at least partially positioned or extends:
a) below the axis A; and/or
b) above the axis A; and/or
c) forwardly of the axis A; and/or
d) rearwardly of the axis A.

41. The load moving apparatus of claim 26, wherein in use, the main body is inclined at an angle to a surface.

42. The load moving apparatus of claim 26 including:
a user graspable handle;
wherein the main body includes first and second respective ends, the first end being positioned closer to a surface in use than the second end;
wherein the ground engaging device is positioned at the first end; and
wherein the user graspable handle is positioned at the second end;
a castor wheel assembly;
wherein the castor wheel assembly is positioned rearwardly of the first end and under the second end.

43. A load moving apparatus for use by a pedestrian including:
a main body;
a battery compartment for receiving a battery device supported on or by the main body;
wherein the battery compartment includes a receiving portion for receiving a weight member; and
a weight member received by the receiving portion, said weight member being positioned adjacent the battery device, in use.

44. The load moving apparatus of claim 43 wherein the weight member is received by the receiving portion on a first lateral side of the battery device, in use;
wherein the load moving apparatus further includes a further weight member, wherein the further weight member is received by the receiving portion on a second, generally opposite, lateral side of the battery device, in use.

45. The load moving apparatus of claim 43 wherein the main body has a further receiving portion for receiving a further weight member;
wherein at least one ground engaging device is supported on or by the main body; and
wherein the apparatus is configured to adopt either of first or second respective configurations; wherein in the first configuration a first weight member is receivable by the further receiving portion, and in the second configuration a second weight member is receivable by the further receiving portion, and wherein the first weight member is different to the second weight member.
